(19) United States
(12) Patent Application Publication
(10) Pub. No.: US 2017/0240476 A1
(43) Pub. Date: Aug. 24, 2017

(54) SYNTHETIC WATER RETENTION AGENT AND RHEOLOGY MODIFIER FOR USE IN CEMENT ADMIXTURES

(71) Applicants: Rohm and Haas Company, Philadelphia, PA (US); Dow Global Technologies LLC, Midland, MI (US)

(72) Inventors: Robert Baumann, Rueschlikon (CH); Philip M. Imbesi, Gilbertsville, PA (US); Thomas Oswald, Galveston, TX (US); Michael J. Radler, Saginaw, MI (US); Marc Schmitz, Verden/Aller (DE); Hongwei Shen, Holmdel, NJ (US)

(21) Appl. No.: 15/521,689

(22) PCT Filed: Oct. 20, 2015
(86) PCT No.: PCT/US2015/055934

§ 371 Date: Apr. 25, 2017

Related U.S. Application Data
(60) Provisional application No. 62/073,356, filed on Oct. 31, 2014.

(51) Int. Cl. C04B 40/00; C04B 24/26; C04B 24/22; C04B 28/04

(52) U.S. Cl. CPC C04B 40/0039; C04B 28/04; C04B 24/2641; C04B 24/226; C04B 24/2647; C04B 2103/32

(57) ABSTRACT

The present invention provides compositions for use as stable additive concentrates, such as aqueous solutions or powders, in cement admixtures comprising i) one or more nonionic or substantially nonionic vinyl or acrylic brush polymers having pendant or side chain polyether groups and having a weight average molecular weight of from 140,000 to 50,000,000, ii) one or more aromatic cofactors containing one or more phenolic groups or, in combination, one or more aromatic groups with at least one sulfur acid group, preferably, a branched aromatic cofactor; and iii) one or more polycarboxylate ether copolymer water reducers containing carboxylic acid or salt groups and having polyether side chains and a weight average molecular weight of from 5,000 to 100,000.

The present invention relates to synthetic polymer compositions for use as stable additive concentrates in cement admixture compositions. More particularly, it relates to compositions comprising i) nonionic or substantially nonionic vinyl or acrylic brush polymers having pendant or side chain polyether groups, ii) one or more aromatic cofactors, such as poly(naphthalene sulfonate) aldehyde resins, and iii) one or more carboxylic acid or salt functional polycarboxylate ether copolymer water reducers having a weight average molecular weight of 100,000 or less, as well as to methods of making them. Finally, it relates to methods of using the compositions in cement or concrete admixtures.

Cellulosics, including cellulose ethers, are well known as viscosity modifying agent (VMAs) additives for their thickening and water retention properties after the introduction of water to them. They are used in concrete mixtures, for example, for cementing well casings used for oil and gas production, and in mortars from dry mixes, such as cement based tile adhesives (CBTA). Unlike water reducers and charged thickeners, cellulose ethers do not ball up in use but stay loosely coiled. Such thickening avoids flocculation or adsorption of the thickener onto alkaline particles in a cement or mortar; this phenomenon can be seen in the fact that cellulose ether polymers associate loosely with one another and retain water between them. This water retention enables wet application of mortar to an absorbing substrate, such as, for example, stone, stone structures, concrete brick or clay brick walls and proper setting before the mortar would dry out. Further, the thickening and water retention provided by a cellulose ether is dosage dependent; and this enables shear thinning and so viscosity of compositions containing cellulose ethers is highly controllable in use. However, cellulose ethers are known to delay the cement setting reaction. This delayed setting will result in lower strength properties.

High performance concrete and to some extent also regular concrete formulations further require the addition of superplastisizers or water reducers, such as polycarboxylate ethers (PCE) to reduce the water to cement ratio and gain strength without losing workability. Such concrete admixtures containing PCEs can contain a high amount of fine particle size fillers, such as limestone powder. These fine fillers are relatively costly; however, reductions in the fine filler content may lead to unstable admixtures. Viscosity modifying agents (VMA) can help retain stability in concrete admixtures having reduced fine filler contents. Thus, it would be desirable to combine VMAs and PCEs.

A growing use of recycled aggregates and crushed rock in concrete makes the formulation very sensitive to water content variation so that even the addition of small amounts of water over the ideal water level results in unstable conditions, such as segregation of the aggregate from concrete and bleeding on its surface. VMAs can enable a broader concrete formulation window in regard to water content. Such VMAs are generally a part of the concrete admixture added to cement/aggregate at a concrete plant. However, most VMAs, especially polysaccharide containing VMAs, like cellulose ethers, will precipitate out when combined with a PCE aqueous solution. While there are synthetic VMAs, like Rheomatrix™ 100 viscosity modifying agents (BASF, Ludwigshafen, DE), that are soluble with PCE solutions; however, due to their strong anionic charge density such synthetic VMAs adsorb on the cement grains and cause setting delays.

U.S. patent publication no. 2011/0054081, to Dierschke et al., discloses additive compositions for concrete admixtures comprising a phosphated structural unit containing polycondensation product and at least one dispersant component chosen from a branched comb polymer having polyether side chains, a naphthalene sulfonate formaldehyde condensate and melamine sulphonate-formaldehyde condensates. The compositions find use in hydraulic binder admixtures as water reducers or superplasticizers which don't excessively delay setting. No compositions are disclosed that could reasonably find use as a viscosity modifying agents or that could efficiently provide the water retention or thickening of a cellulose ether. Further, known superplasticizers cannot work as a substitute for cellulose ethers because they do not readily thicken cement admixtures or mortars; instead, superplasticizers lower the viscosity of cement (“fluidity”—see [0007]) admixtures and exhibit water reduction, not water retention.

The present inventors have sought to solve the problem of making a storage stable viscosity modifying agent and water reducer additive composition that in cement admixtures gives the thickening and water retention performance of cellulose ethers, without any of the delayed setting caused by cellulose ethers and without excessive bleeding and segregation.

### STATEMENT OF THE INVENTION

1. In accordance with the present invention, compositions for use as stable additive concentrates in cement admixture compositions comprise i) one or more nonionic or substantially nonionic vinyl or acrylic brush polymers having pendant or side chain polyether groups, preferably, alkoxy poly(alkylene glycol) groups and having a relative weight average molecular weight (relative Mw) of from 140,000 to 50,000,000 g/mol, or, preferably, 250,000 or more, or, more preferably, 300,000 or more, or, preferably, 5,000,000 or less, or, even more preferably, 2,500,000 or less, ii) one or more aromatic cofactors containing one or more phenolic groups or, in combination, one or more aromatic groups with at least one sulfur acid group, such as, for example, a poly(naphthalene sulfonate) formaldehyde condensate resin or a styrene sulfonate (co)polymer; and iii) one or more polycarboxylate ether copolymer water reducers containing carboxylic acid or salt groups and having polyether side chains, preferably, alkoxy poly(ethylene glycol) groups or polyethylene glycol groups, and a weight average molecular weight of from 5,000 to 100,000, or, preferably, 75,000 or less, or, more preferably, 50,000 or less.

2. In accordance with the present invention as in the compositions of item 1, above, the weight ratio of the total amount of i) brush polymer solids to the total amount of ii) aromatic cofactor solids ranges from 1:0.25 to 1:10, or, preferably, from 1:1 to 1:5. Preferably, where the i) one or more brush polymers is an ethoxylated polyvinyl alcohol (ethoxylated PVOH) brush polymer, the weight ratio the total amount of i) brush polymer solids to ii) aromatic cofactor solids ranges from 1:2 to 1:3; and, preferably, where the i) one or more brush polymers has a relative weight average molecular weight above 750,000, the weight ratio the total amount of i) brush polymer solids to ii) aromatic cofactor solids ranges from 1:1 to 1:2.

3. In accordance with the present invention as in the compositions of items 1 or 2, above, wherein the ii) one or more aromatic cofactor is chosen from a naphthalene sulfonate aldehyde condensate polymer, such as a beta-naphthalene sulfonate formaldehyde condensate polymer, such as beta naphthalene sulfonate resin (BNS), a poly(styrene-co-styrene sulfonate) copolymer, lignin sulfonate, catechol tannins, phenolic resins, such as phenol formaldehyde resins, polyphenolics, napthhols, such as 2-naphthol, and mixtures thereof; preferably the aromatic cofactor is branched and, more preferably, is BNS.

4. The compositions of the present invention as in any one of items 1 to 3, above, the average number of ether groups in the pendant or side chain polyether groups of the i) one or more brush polymers ranges from 1.5 to 100 ether groups, or, from 1.5 to 50 ether groups, or, preferably, from 3 to 40, or, more preferably, from 5 to 25 ether groups.

5. The compositions of the present invention as in any one of items 1 to 4, above, wherein the i) one or more brush polymers is chosen from a polyethoxylated polyvinyl alcohol; a homopolymer of a macromonomer a) having a pendant or side chain polyether group, such as polyethylene glycol (meth)acrylates, alkoxy polyethylene glycol (meth)acrylates, hydrophobic C₁₂ to C₂₅ alkoxy poly(alkylene glycol) (meth)acrylates, and, preferably, polyethylene glycol (meth)acrylates and methoxy polyethylene glycol (meth)acrylates; a copolymer of one or more macromonomers a) and one or more monomers b) chosen from lower alkyl (C₁ to C₄) alkyl (meth)acrylates, preferably, methyl methacrylate, and ethyl acrylate; hydroxyalkyl (meth)acrylates, preferably, hydroxyethyl methacrylate; diethylenically unsaturated crosslinker monomers; and mixtures thereof.

6. The compositions of present invention as in any one of 1 to 5, above, wherein at least one of the i) one or more brush polymers is the copolymerization product of a monomer mixture having from 20 to 100 mole %, or from 30 to 99.9 mole %, or from 40 to 70 mole %, or, preferably, from 70 to 99.9 mole %, of pendant or side chain polyether group containing monomers, such as a macromonomer a), based on the total weight of monomers used to make the brush polymer.

7. The compositions of present invention as in any one of 1 to 6, above, wherein the iii) polycarboxylate ether copolymer water reducers comprise backbone polymers of (meth)acrylic acid having a backbone polymer weight average molecular weight of from 1,000 to 20,000, or, preferably, 2,000 or more, or, preferably, 15,000 or less, or, more preferably, from 1,000 to 10,000, and one or more polyether polyol, alkyl polyether polyol, polyether amine or alkyl polyether amine as side chains bound to the backbone through a carboxylic acid ester linkage, such as via grafting onto a polymeric polyacid.

8. The compositions of present invention as in any one of 1 to 7, above, wherein the polyether side chains contain repeat ether units having from 1 to 4 carbon atoms, preferably, 2 carbon atoms.

9. The compositions of the present invention as in any of 1 to 8, above, which comprise an aqueous additive mixture having a solids content of from 25 to 70 wt. %.

10. The compositions as in any of 1 to 9, above, further comprising a hydraulic or moisture curing inorganic cement, wherein the total amount of the i) one or more brush polymer, as solids, ranges from 0.05 to 2 wt. %, or, preferably, from 0.1 to 1 wt. %, or, more preferably, from 0.2 to 0.5 wt. %, based on total cement solids.

11. The compositions as in any of 1 to 10, above, further comprising a hydraulic or moisture curing cement, wherein the total amount of the ii) one or more aromatic cofactors, as solids, ranges from 0.1 to 10 wt. %, or, preferably, from 0.2 to 5 wt. %, or, more preferably, from 0.2 to 2 wt. %, based on total cement solids.

12. In accordance with the present invention, methods for making the compositions as in any of items 1 to 9, above, comprise any one of:

drying or obtaining as a powder each of i) one or more brush polymers, the ii) one or more aromatic cofactors and iii) the one or more polycarboxylate ether copolymer water reducers, and mixing them to form a dry powder blend; or,

adding in any order to an aqueous solution of the iii) one or more polycarboxylate ether copolymer water reducers, each of the i) one or more brush polymers, the ii) one or more aromatic cofactors, or a mixture or i) and ii) to form a stable aqueous additive composition.

13. In accordance with the present invention, methods for using the compositions as in any of items 1 to 9, above, comprise adding the i) one or more vinyl or acrylic brush polymers and the ii) one or more aromatic cofactors in any form to an aqueous solution of the iii) one or more polycarboxylate ether copolymer water reducers to form an aqueous additive mixture for use in wet hydraulic cement.

14. In accordance with the present invention, methods of using the compositions of any of items 1 to 8, above, comprise adding the i) one or more vinyl or acrylic brush polymers in any form to the a hydraulic cement and then adding, one at a time or together, preferably, as an aqueous mixture, ii) one or more aromatic cofactors and the iii) one or more polycarboxylate ether copolymer water reducers, to form a cement admixture.

In accordance with any of items 13 or 14, above, the methods may further comprise applying the thus formed cement admixture to a substrate. The applied cement admixture may further be allowed to cure.

The iii) water reducers in any of items 1 to 11, above, can be polycarboxylate ether polymers and/or polycarboxylate ester polymers.

As used herein, the term “acrylic or vinyl polymer” refers to addition polymers of α, β-ethylenically unsaturated monomers, such as, for example, alkyl and hydroxyalkyl (meth)acrylates, vinyl ethers, ethylenically unsaturated carboxylic acids, polyethoxy group containing monomers, such as, for example, methoxypolyethylene glycol (meth)acrylate (mPEG(M)A) or polyethylene glycol (meth)acrylate (PEG(M)A) and allyl polyethylene glycol (APEG).

As used herein, the phrase “aqueous” includes water and mixtures composed substantially of water and water-miscible solvents, preferably, such mixtures having more than 50 wt. % water, based on the total weight of water and any water-miscible solvents.

As used herein, unless otherwise indicated, the term “average number of ether groups in the pendant or side chain polyether groups” of a brush polymer refers to the number of ether groups given in manufacturer's literature for an addition monomer such as a macromonomer a) or, in the case of an ethoxylated polyvinyl alcohol as indicated, the calculated average number of ether groups per alcohol group contained in the reaction mixture used to make the ethoxylated PVOH or the mass of ether group compounds actually reacted with the PVOH to make the ethoxylated PVOH, adjusted for the % or number of hydroxyl groups in the PVOH. As this is an average number, the actual number of ether groups in any one pendant or side chain polyether group will vary; and some brush polymer repeat units may have no side chain or pendant polyether group at all.

As used herein, the phrase “based on total solids” refers to weight amounts of any given ingredient in comparison to the total weight amount of all of the non-volatile ingredients in the aqueous composition, including synthetic polymers, natural polymers, acids, defoamers, hydraulic cement, fillers, other inorganic materials, and other non-volatile additives. Water, ammonia and volatile solvents are not considered solids.

As used herein, the term “based on the total weight of monomers” refers to the amount of a polymer or portion thereof compared to the total weight of addition monomers used to make the polymer, such as, for example, vinyl monomers.

As used herein, the term “copolymerization residue” of a given monomer refers to the polymerization product in a polymer that corresponds to that monomer. For example, the copolymerization residue of an mPEGMA (methoxypoly(ethyleneglycol) methacrylate) monomer is a polyethylene glycol side chain linked via an ester group to a methacrylic acid in polymerized form, i.e., having no double bond, situated within or at one end of an addition polymer backbone.

As used herein, the phrase “nonionic” with respect to brush polymers means that no monomer that was used to make the polymer has an anionic or cationic charge at a pH of from 1 to 14.

As used herein, the term “pendant” group refers to a side chain of a polymer or a group that is covalently linked to the backbone of a polymer and which is not an endgroup.

As used herein, unless otherwise indicated, the phrase “polymer” includes both homopolymers and copolymers from two or more than two differing monomers, as well as segmented and block copolymers.

As used herein, the term “storage stable” means that, for a given powder additive composition, the powder will not block and, for a given aqueous additive composition, the liquid composition will not become cloudy, separate or precipitate after 5 days, or, preferably, 10 days when allowed to stand on a shelf under room temperature conditions and standard pressure.

As used herein, the term “substantially nonionic” means a polymer composition that at a pH of from 1 to 14 contains less than 10×10⁻⁴ mol of added anionically or cationically charged monomers or polymer repeat units e.g., a saccharide unit in a cellulosic polymer or a monomer polymerization residue in an addition polymer, per gram of polymer, based on the total solids in the polymer, or, preferably, 5×10⁻⁵ mol/g polymer or less. Such polymers are made by polymerizing a monomer mixture containing no anionically or cationically charged monomers. Anionic or cationic monomers that happen to be present as an impurity in nonionic monomers used in making the brush polymers of the present invention, such as macromonomer a) or monomer b), are not considered to be “added” anionically or cationically charged monomers.

As used herein, the term “sulfur acid group” means any of a sulfate, sulfonate, sulfite, and bisulfite group, such as a metabisulfite.

As used herein, the term “use conditions” refers to standard pressure and ambient temperatures at which a given composition may be used or stored.

As used herein, the term “weight average molecular weight” for a polyether carboxylate polymer means the weight average value taken from the weight distribution determined by gel permeation chromatography using polyacrylic acid standards as needed to resolve the molecular weight of the given polymer.

As used herein, unless otherwise indicated, the term “relative weight average molecular weight” or “relative Mw” refers to a relative weight average molecular weight (Relative MW) as determined using an Agilent 1100 GPC system (Agilent Technologies, Lexington, Mass.) equipped with a differential reflective index detector set at a temperature of 40° C. Two columns in series at 40° C., one a TSKgel G2500PWXL with 7 μm hydrophilic polymethacrylate beads and the other a TSKgel GMPWXL with 13 μm hydrophilic polymethacrylate beads, were used for polymer separation. As the aqueous mobile phase, a 20 mM phosphate buffer aqueous composition at a pH adjusted to 7.0 using NaOH was used for separation with a flow rate of 1 mL/min. MW averages were determined using Varian Cirrus GPC/SEC Software Version 3.3 (Varian, Inc., Palo Alto, Calif.). Polyacrylic acid standards from American Polymer Standards (Mentor, Ohio) were used to calibrate the GPC system and generate a calibration curve. In determining Relative MW, the calibration curve was used for subsequent Relative MW calculation, for example, for assigning a weight average molecular weight to the ethoxylated PVOH polymers.

As used herein, unless otherwise indicated, the term “wt. %” or “wt. percent” means weight percent based on solids.

The singular forms “a,” “an,” and “the” include plural referents unless the context clearly dictates otherwise. Unless defined otherwise, the terms used herein have the same meaning as is commonly understood by one skilled in the art.

Unless otherwise indicated, any term containing parentheses refers, alternatively, to the whole term as if no parentheses were present and the term without that contained in the parentheses, and combinations of each alternative. Thus, the term “(meth)acrylate” encompasses, in the alternative, methacrylate, or acrylate, or mixtures thereof.

The endpoints of all ranges directed to the same component or property are inclusive of the endpoint and independently combinable. Thus, for example, a disclosed range of a weight average molecular weight of from 140,000 to 50,000,000 g/mol, or, preferably, 250,000 or more, or, more preferably, 300,000 or more, or, preferably, 5,000,000 or less, or, even more preferably, 2,500,000 or less means any or all of such molecular weights ranging from 140,000 to 250,000, from 140,000 to 300,000, from 140,000 to 2,500,000, from 140,000 to 50,000,000, from 140,000 to 5,000,000, or, preferably, from 250,000 to 300,000, or, preferably, from 250,000 to 2,500,000, or, from 250,000 to 50,000,000, or, preferably, from 250,000 to 5,000,000, or, more preferably, from 300,000 to 2,500,000, or, preferably, from 300,000 to 5,000,000, or, from 300,000 to 50,000,000, or, preferably, from 2,500,000 to 5,000,000 or from 5,000,000 to 50,000,000.

Unless otherwise indicated, conditions of temperature and pressure are room temperature and standard pressure, also referred to as “ambient conditions”. The aqueous binder compositions may be dried under conditions other than ambient conditions.

The present invention provides shelf stable additive compositions that are completely soluble in a polycarboxylate ester copolymer (PCE) solution. The compositions of the present invention partly or wholly replace cellulose ethers and superplasticizers. Thus, the compositions of the present invention act in hydraulic cement compositions, one the one hand, as water retention agents and viscosifiers, and, on the other hand, as water reducers. The brush copolymers of the present invention effectively complex with the aromatic cofactors of the present invention in a nonionic interaction that results in thickening and water retention in cements that is comparable to those same effects observed when the adding same amount of a cellulose ether. The vinyl or acrylic brush polymers have a high Mw and pendant or side chain polyether groups, such as polyethylene glycols, which complex with aromatic cofactors, such as beta-naphthalene sulfonate formaldehyde condensate polymer (BNS), poly(styrene-co-styrene sulfonate) copolymer, and lignin sulfonate. Further, such brush polymers, like cellulose ethers, have minimal ionic adsorption behavior onto inorganic or hydraulic cement surfaces thereby enabling water retention in aqueous inorganic and hydraulic cement compositions. Because of the minimal ionic adsorption behavior of the brush polymers, the stable aqueous additive compositions of the present invention can comprise both a VMA and a polycarboxylate ester copolymer. The resulting shelf stable compositions in water have a very high solution viscosity at low concentration and provide high viscosity and effective water retention in cement admixtures without an undesirable amount of setting retardation. In addition, the compositions prevent bleeding and segregation in cement admixtures and wet concrete.

The cofactor of the present invention can be any compound, polymer or oligomer having one or more and up to 1,000,000, or up to 100,000, or, preferably, two or more, or, more preferably, three or more aromatic groups or phenolic groups, such as, for example, phenolic or naphtholic groups, wherein when the aromatic cofactor has aromatic groups other than phenolic groups it further contains at least one sulfur acid group. Preferably, the aromatic cofactor of the present invention has one or more aromatic group and at least one sulfur acid group, or, more preferably, two or more such combinations. These cofactors can include BNS, styrene sulfonate (co)polymers, and lignin sulfonates, as well as phenolic resins, tannins and naphthols.

The oligomeric or polymeric aromatic cofactors of the present invention have aromatic or phenolic groups on from 10 to 100%, or, preferably, from 30 to 100%, or, more preferably, from 50 to 100% or from 60 to 100% of the repeat units of the oligomer or polymer. For example, each of a phenol formaldehyde resin or a naphthalene sulfonate aldehyde resin is considered a homopolymer or oligomer having, respectively, phenolic groups or aromatic groups in 100% of its repeating units. Preferably, in oligomers or polymers having aromatic and sulfur acid groups in combination, more than 30 wt. % or, preferably, more than 50 wt. %, of the aromatic groups are accompanied by a sulfur acid group, such as, for example, poly(stryrene-co-styrene sulfonate) copolymers which are the copolymerization product of more than 30 mole % of styrene sulfonate, based on the total number of moles of vinyl monomers used to make the copolymer.

The aromatic cofactor may be linear, as in styrene sulfonate containing polymers, and is, preferably, branched, as in any condensate resin, such as naphthalene sulfonate aldehyde or phenol aldehyde condensates, tannins or lignin sulfonates.

Where the aromatic cofactor is linear, it preferably has a molecular weight of 600,000 to 10,000,000.

Suitable examples of aromatic cofactors are commercially available, including Melcret™ 500 powder (BASF, Ludwigshafen, DE) and the liquid version thereof, Melcret™ 500 L liquid (BASF). Both are BNS polymers or oligomers. Melcrete™ 500 polymer is a sulfonated naphthalene condensate with formaldehyde.

The vinyl or acrylic brush polymers of the present invention can comprise any such polymers having pendant or side chain polyether groups, preferably, polyethylene glycols or alkoxy poly(ethylene glycols). The pendant or side chain polyether groups help the polymers to be water soluble or at the least to be water dispersible. Such pendant or side chain polyether groups can be, for example, polyalkylene glycol side chains terminated with hydroxyl, methyl, ethyl or any other non-ionic group. The side chains can be pure alkylene glycols (EO, PO, BO, etc.) or mixtures thereof. Suitable pendant or side chain polyether groups may be chosen from polyalkylene glycols, such as polyethylene glycol, polypropylene glycol, polybutylene glycols or copolyethers of two of more thereof; alkoxy poly(alkylene glycol)s, such as methoxy poly(alkylene glycol)s, ethoxy poly(alkylene glycol)s and their combination.

Preferably, the pendant or side chain polyether groups in the vinyl or acrylic brush polymers of the present invention have from 5 to 25, or, more preferably, from 7 to 15 ether groups or alkylene glycol groups. More preferably, the ether groups are ethoxy (—CH₂CH₂O—)groups.

The backbone of the vinyl or acrylic brush polymers of the present invention consists of repeating units of acrylic or methacrylic acid esters or vinyl esters; however, the repeating units are not limited to these. The vinyl or acrylic brush polymers of the present invention can also can be synthesized using of any other unsaturated monomers, such as vinyl-, allyl-, isoprenyl-groups.

An example of an acrylic brush polymer having pendant or side chain polyether groups is a (co)polymer of an acrylate or acrylamide macromonomer a) having a pendant or side chain polyether group. Such macromonomers a) have large pendant hydrophilic groups, such as polyethylene glycol, that can help the polymers to be water soluble or at the least to be water dispersible.

Suitable acrylic brush polymers having pendant or side chain polyether groups are the polymerization product of a) from 20 to 100 wt. %, or, 20 to 90 wt. %, or, 40 to 70 wt. %, or, preferably, 30 wt. % or more, or, preferably, up to 80 wt. %, or, more preferably, from 70 to 99.9 wt. %, such as 90 wt. % or more, based on the total weight of the monomers used to make the polymer, of one or more macromonomer a) having a pendant polyether group, such as polyethylene glycol (meth)acrylates, alkoxy polyethylene glycol (meth)acrylates, hydrophobic C₁₂ to C₂₅ alkoxy poly(alkylene glycol)s, and, preferably, polyethylene glycol (meth)acrylates and methoxy polyethylene glycol (meth)acrylates and b) as the remainder of the monomers used to make the polymer, one or more vinyl or acrylic monomer b).

Suitable macromonomers a) for making the acrylic brush polymers of the present invention may be any macromonomer having a poly(alkylene glycol) with the desired number of ether or alkylene glycol units, such as, for example, a polyethylene glycol (meth)acrylate or its corresponding (meth)acrylamide having from 2 to 50 ethylene glycol units, polypropylene glycol (meth)acrylate or its corresponding (meth)acrylamide having from 2 to 50 propylene glycol units, a C₁₂ to C₂₅ alkoxy polyethylene glycol (meth)acrylate or its corresponding (meth)acrylamides having from 2 to 50 ethylene glycol units and, a C₁₂ to C₂₅ alkoxy polypropylene glycol (meth)acrylate or its corresponding (meth)acrylamide having from 2 to 50 propylene glycol units, polybutylene glycol (meth)acrylate or its corresponding (meth)acrylamide having from 2 to 50 total alkylene glycol units, polyethylene glycol-polypropylene glycol (meth)acrylate or its corresponding (meth)acrylamide having from 2 to 50 total alkylene glycol, polyethylene glycol-polybutylene glycol (meth)acrylate or its corresponding (meth)acrylamide having from 2 to 50 total alkylene glycol units, polypropylene glycol-polybutylene glycol (meth)acrylate or its corresponding (meth)acrylamide having from 2 to 50 total alkylene glycol units, polyethylene glycol-polypropylene glycolpolybutylene glycol (meth)acrylate or its corresponding (meth)acrylamide having from 2 to 50 total alkylene glycol units, methoxypolyethylene glycol (meth)acrylate or its corresponding (meth)acrylamide having from 2 to 50 ethylene glycol units, methoxypolypropylene glycol (meth)acrylate or its corresponding (meth)acrylamide having from 2 to 50 propylene glycol units, methoxypolybutylene glycol (meth)acrylate or its corresponding (meth)acrylamide having from 2 to 50 total alkylene glycol units, methoxypolybutylene glycol mono(meth)acrylate or its corresponding (meth)acrylamide having from 2 to 50 total alkylene glycol units, methoxypolyethylene glycol-polypropylene glycol (meth)acrylate or its corresponding (meth)acrylamide having from 2 to 50 total alkylene glycol units, methoxypolyethylene glycol-polybutylene glycol (meth)acrylate or its corresponding (meth)acrylamide having from 2 to 50 total alkylene glycol units, methoxypolypropylene glycol-polybutylene glycol (meth)acrylate or its corresponding (meth)acrylamide having from 2 to 50 total alkylene glycol units, methoxypolyethylene glycol-polypropylene glycol-polybutylene glycol (meth)acrylate or its corresponding (meth)acrylamide having from 2 to 50 total alkylene glycol units, ethoxypolyethylene glycol (meth)acrylate or its corresponding (meth)acrylamide having from 2 to 50 ethylene glycol units, polyethylene glycol (meth)allyl ether or monovinyl ether having from 2 to 50 ethylene glycol units, polypropylene glycol (meth)allyl ether or monovinyl ether having from 2 to 50 propylene glycol units, polyethylene glycol-polypropylene glycol (meth)allyl ether or monovinyl ether having from 2 to 50 total alkylene glycol units, polyethylene glycol-polybutylene glycol (meth)allyl ether or monovinyl ether having from 2 to 50 total alkylene glycol units, polypropylene glycol-polybutylene glycol (meth)allyl ether or monovinyl ether having from 2 to 50 total alkylene glycol units, methoxypolyethylene glycol (meth)allyl ether or monovinyl ether having from 2 to 50 ethylene glycol units, methoxypolypropylene glycol (meth)allyl ether or monovinyl ether having from 2 to 50 propylene glycol units, and the corresponding monoesters, monoamides, diesters and diamides of itaconic or maleic acids, or mixtures of any of the foregoing.

Preferably, the macromonomers a) used to make the vinyl or acrylic brush polymers of the present invention have pendant or side chain polyether groups with from 5 to 25 total alkylene glycol or ether units, such as 7 or more alkylene glycol or ether units, or, up to 15 alkylene glycol or ether units.

Preferably, the macromonomers a) used to make the vinyl or acrylic brush polymers of the present invention are methacrylate monomers.

More preferably, the macromonomers a) are chosen from polyethylene glycol (meth)acrylate (PEG(M)A) methoxypoly(ethylene glycol) (meth)acrylate (MPEG(M)A), or their mixture.

The monomers b) used to make the acrylic brush polymers of the present invention may be chosen from lower alkyl (C₁ to C₄) alkyl (meth)acrylates, preferably, methyl methacrylate, and ethyl acrylate; hydroxyalkyl (meth)acrylates, preferably, hydroxyethyl methacrylate; diethylenically unsaturated crosslinker monomers, such as polyethylene glycol di(meth)acrylates, ethylene glycol-dimethacrylate, ethylene glycol diacrylate, allyl acrylate or allyl methacrylate; and their combination.

The vinyl or acrylic brush polymers of the present invention may be crosslinked. Crosslinking may result from methods such as by including in the copolymerization reaction medium from 0.01 to 5 wt. %, or, preferably, from 0.02 to 2 wt. % of one or more diethylenically unsaturated crosslinker monomers, such as (poly)glycol di(meth)acrylates, like (poly)ethylene glycol dimethacrylates or (poly)ethylene glycol diacrylates; allyl acrylate or allyl methacrylate; or their combination, based on the total weight of the monomers used to make the polymer.

Preferably, to insure that the vinyl or acrylic brush polymers of the present invention exhibit water retention and not water reduction, such polymers are substantially nonionic. Therefore, such vinyl or acrylic brush polymers are the polymerization product of less than 0.1 wt. % or, preferably, less than 0.05 wt. % of an ethylenically unsaturated carboxylic acid or salt monomer, based on the total weight of monomers used to make the brush polymer.

The vinyl or acrylic brush polymers of the present invention are made by conventional free radical addition polymerization in the presence of a thermal or a redox initiator, such as, for example, aqueous emulsion polymerization in the presence of persulfates.

Preferably, the acrylic brush polymers of the present invention are made via conventional free radical addition polymerization, such as shot polymerization wherein the monomer reactants are added to a reaction vessel all at one time.

Preferably, to insure the highest molecular weight vinyl or acrylic brush polymer, addition polymerization is conducted in aqueous solution with a thermal initiator, such as a persulfate or a peracid.

Preferably, to insure the highest molecular weight vinyl or acrylic brush polymer product, addition polymerization is conducted in aqueous solution at a temperature of from 40 to 80° C., or, more preferably, 71° C. or less.

More preferably, to insure the highest molecular weight brush polymer product, polymerization is conducted in aqueous solution with a thermal initiator, at a temperature of from 40 to 75° C., or, most preferably, 71° C. or less.

Most preferably, to insure the highest molecular weight vinyl or acrylic brush polymer product, polymerization is conducted in aqueous solution with a thermal initiator, at a concentration of 0.05 wt. % to 1 wt. %, based on the total weight of monomers (monomer solids) used to make the polymer, or, even more preferably, 0.08 wt. % or more.

Still further, vinyl or acrylic brush polymers having two or more branches may be made via aqueous initiation polymerization of a macromonomer a) in the presence of a di-ethylenically unsaturated comonomer, such as allyl methacrylate or a (poly)glycol di(meth)acrylate.

The ethoxylated polyvinyl alcohol (ethoxylated PVOH) brush copolymers of the present invention may be made by grafting ethylene oxide to hydrolyzed vinyl ester (co)polymers, such as hydrolyzed polyvinyl acetates. The hydrolyzed vinyl ester (co)polymer reactants may have a weight average molecular Mw of from 50,000 to 1,000,000 g/mol or, preferably, 100,000 or more, as reported in manufacturer's literature or as determined by gel permeation chromatography using polyvinyl alcohol standards.

Suitable methods for making the ethoxylated PVOH of the present invention may be found in, for example, U.S. Pat. No. 1,971,662A to Schmidt et al. and in U.S. Pat. No. 3,052,652A to Halpern et al., which discloses grafting in an aqueous suspension. Desirably, solvents or diluents are used wherein the PVOH is initially a slurry and wherein the ethoxylated product is soluble as in U.S. Pat. No. 2,434,179A to Sharkey. Also, the ethoxylated PVOH brush polymer can be made by grafting pendant or side chain polyether groups in the presence of a suitable catalyst in an organic solvent solution as in U.S. Pat. No. 2,844,570A to Aubrey.

The partially hydrolyzed polyvinyl ester polymer may suitably be hydrolyzed to an extent of from 30 to 100%, or, 50% or more, or, preferably, from 85 to 100% of the total repeat units in the polyvinyl ester polymer. Lower levels of hydrolysis help keep the polyvinyl ester soluble in low boiling aprotic solvents useful for economical solution polymerization; hence, polyvinyl alcohols having a greater than 30% hydrolysis may also be ethoxylated in a slurry process with diluent such as xylene.

The ethoxylated PVOH brush polymer may have a relative Mw of from 140,000 to 1,000,000 or, preferably, 250,000 or more, or, more preferably, 350,000 or more.

If a higher weight average molecular weight polyethoxylated polyvinyl alcohol is desired, the resulting graft product can be dialyzed to remove lower molecular weight fractions. The grafting or ethoxylation reaction temperature may range from 120 to 190° C., or, preferably, from 140-170° C.

Suitable amounts of pendant or side chain polyether groups in the polyethoxylated polyvinyl alcohols of the present invention may range from 1:1 to 50:1, or, preferably, from 2:1 to 20:1, or, more preferably, from 3:1 to 10:1, or, even more preferably, from 4.5:1 to 5.5:1, expressed as the ratio of weight of the pendant polyether groups, like poly(ethylene oxide), to the total weight of the PVOH polymer in the ethoxylated PVOH brush polymer.

Preferably, the polyethoxylated polyvinyl alcohol of the present invention is a polyethoxylated polyvinyl alcohol comprising, in copolymerized form, hydrolyzed or partially hydrolyzed vinyl acetate.

Suitable catalysts for use in the ethoxylation or grafting of hydrolyzed polyvinyl ester to an ethoxy side chain may include, for example, a methoxide such as sodium methoxide (NaOMe), potassium methoxide (KOMe); a hydride such as NaH; a double metal cyanide (DMC), such as those described in U.S. Pat. No. 6,586,566 to Hofmann et al.; alkylated metal catalysts, such as butyl lithium; or an alkali metal hydroxide.

Suitable amounts of catalyst may range from 100 ppm to 10,000 ppm (1 wt. %), based on total reactant and catalyst solids, or, preferably, from 200 to 1,000 ppm, or, preferably, 500 ppm or less.

Suitable solvents or carrier for grafting or ethoxylation may include, for example, polar solvents such as, for example, 2-methyl pyrrolidone, dimethyl formamide (DMF), and dimethyl sulfoxide (DMSO).

Where an organic solvent is used in ethoxylation or grafting, the hydrolyzed polyvinyl ester should contain 10 wt. % water or less, based on the weight of the polyvinyl ester polymer and the carrier or liquid phase, or, preferably, less than 1 wt. % water.

The polyethoxylated polyvinyl alcohol is preferably dried. Drying may be done by heating, preferably, drying in a vacuum oven or by an azeotropic method as described in the prior art. Methyl ethyl ketone (MEK) is preferably used as the solvent for azeotropic removal of water from the reactant polyvinyl alcohol (PVOH) used in making the brush polymer.

The iii) polycarboxylate ether copolymer water reducers of the present invention can comprise a polycarboxylate ester or polycarboxylate ether polymer or any polymer that has both carboxylic acid or salt groups and polyether side chain groups; however, the molecular weight of the iii) polycarboxylate ether copolymer water reducers is far lower than that of the i) brush polymers of the present invention. The lower molecular weights may result from any of or all of gradual addition polymerization, raising the polymerization temperature to 80 to 100° C., and the use of chain transfer agents, especially in higher amounts of up to 25 wt. %, based on the total weight of the monomer mixture used to make the polycarboxylate ester copolymer.

As used herein, the term “polycarboxylate ester” copolymer refers copolymers having carboxylic acid or salt groups and ester groups linking the polymer backbone to a polyether side chain.

A polycarboxylate ester copolymer can be any graft modified polymeric polyacid made from an ethylenically unsaturated carboxylic acid, or its salt by aqueous solution polymerization via conventional methods, followed by grafting via polyglycol esterification or aminopolyglycol amidation of the polymeric polyacid to add the polyether side chains. Such polymeric polyacids and methods for esterifying or amidating them are known in the art, as in U.S. Pat. No. 6,384,111 B1, to Kistenmacher et al. Thus, in accordance with the present invention, polycarboxylate esters include within their scope a polycarboxylate amides.

Preferably the polyglycol or aminopolyglycol comprises ethoxy (—CH₂CH₂O—) groups. More preferably, the polyglycol or aminopolyglycol is 1 to 4 carbon alkyl or methyl capped.

Preferably, the polymeric polyacid used to make a polycarboxylate ester copolymer by grafting further comprises phosphorus oxide groups, such as those provided by using phosphites, hypophophosphites, or their salts, such as sodium hypophosphites. Such phosphites and hypophosphites act as chain transfer agents. Such materials and polymeric polyacids are known in the art, as in U.S. Pat. No. 7,906,591 B2, to Weinstein et al. The polymeric polyacid is then esterified or amidated.

A polycarboxylate ester copolymer can also be an addition copolymer made by aqueous addition polymerization in the presence of an initiator, i.e., the same manner as the acrylic brush polymers of the present invention, of a monomer mixture of an ethylenically unsaturated carboxylic acid, or its salt, preferably, methacrylic acid, with any macromonomer a) or other polyether group containing ethylenically unsaturated monomer that contains an ester linkage between the ethylenic unsaturation and the polyether group, for example, a methoxypolypropylene glycol (meth)acrylate.

As used herein, the term “polycarboxylate ether polymer” refers to an addition copolymer made by aqueous addition polymerization in the presence of an initiator, i.e., the same manner as the acrylic brush polymers of the present invention, of a monomer mixture of an ethylenically unsaturated carboxylic acid, or its salt, preferably, methacrylic acid, with any macromonomer a) or other polyether group containing ethylenically unsaturated monomer that contains an ether linkage between the ethylenic unsaturation and the polyether group, for example, an allyl ethoxylate or a methoxypolypropylene glycol (meth)allyl ether or monovinyl ether.

Preferably, the polyglycol or aminopolyglycol in the iii) polycarboxylate ether copolymer water reducer comprises ethoxy (—CH₂CH₂O—) groups. More preferably, the polyglycol or aminopolyglycol is 1 to 4 carbon alkyl or methyl capped.

Preferably, the polyether groups in the iii) polycarboxylate ether copolymer water reducer of the present invention have from 5 to 500 or from 5 to 100, or, preferably, from 5 to 75 or, preferably, from 7 to 50 ether groups or alkylene glycol groups.

The compositions of the present invention can be used in wet or dry form. Drying may be done by spray drying, heating, preferably in a vacuum oven or by an azeotropic method as described in the prior art. For example, methyl ethyl ketone (MEK) is a suitable solvent for azeotropic removal of water from vinyl brush polymers made by other than aqueous polymerization methods.

The aromatic cofactor of the present invention can be used in wet or dry form and can be combined with the vinyl or acrylic brush polymers to make an additive composition.

The compositions may be used by admixing them with hydraulic binders and water to make concrete or cement admixture. The composition of the present invention can be combined with hydraulic cements in any manner so long as the aromatic cofactor is not added to wet cement, prior to addition of the vinyl or acrylic brush polymer and the iii) polycarboxylate ether copolymer water reducer to the wet cement. Preferably, the compositions of the present invention comprise a single aqueous composition that is added to the wet concrete or cement.

In the compositions of the present invention, the vinyl or acrylic brush polymers and the aromatic cofactors are combined such that in use the total amount of brush polymer dosage to the total solid content of the cement admixture (including organic solids) ranges from 0.05 to 2 wt. %, or, preferably, from 0.1 to 1 wt. %

In the compositions of the present invention, the vinyl or acrylic brush polymers and the aromatic cofactors are combined such that in use the total amount of brush polymer dosage to the total cement solids content of the cement admixture ranges from 0.1 to 5 wt. %, or, preferably, from 0.2 to 2 wt. %.

In the compositions of the present invention, the total amount of the iii) polycarboxylate ether copolymer water reducer ranges from 0.1 to 10 wt. %, or, preferably, from 0.2 to 5 wt. % of the total cement solids content of the cement admixture.

The compositions of the present invention may further comprise a cellulose ether, such as HPMC and/or HEMC (hydroxyethyl methyl cellulose).

The compositions of the present invention can contain, in addition, conventional additives in wet or dry form, such as, for example, cement setting accelerators and retarders, air entrainment agents or defoamers, shrinking agents and wetting agents; surfactants, particularly nonionic surfactants; spreading agents; mineral oil dust suppressing agents; biocides; plasticizers; organosilanes; anti-foaming agents such as dimethicones and emulsified poly(dimethicones), silicone oils and ethoxylated nonionics; and coupling agents such as, epoxy silanes, vinyl silanes and hydrophobic silanes.

### EXAMPLES

The following examples serve to illustrate the present invention. Unless otherwise indicated, the preparations and test procedures are carried out at ambient conditions of temperature and pressure.

The following abbreviations are used, below:

HEMA: Hydroxyethyl methacrylate; MMA: Methyl methacrylate; EGDMA: Ethyleneglycol dimethacrylate; xEGMA: various ethylene glycol methacrylates.

Acrylic Brush Polymer Synthesis Process: All acrylic brush polymers were synthesized in an aqueous solution shot polymerization process via free radical polymerization. Unless otherwise specified, a 1000 mL 4-neck round bottom reaction flask coupled with a thermo-couple, an overhead stirrer and a condenser was used for all polymer synthesis and a heating mantel was used to control reaction temperature. Unless stated otherwise, all chemicals used were from Sigma Aldrich (St. Louis, Mo.). All monomer reactants and a fixed amount of de-ionized water were charged first into the reactor. After the temperature rose to a targeted temperature of 70° C. (unless stated otherwise), a controlled initial dosage of initiators was added and the temperature was held constant for two hours. After the two-hour polymerization, a second dosage of initiators was used to reduce the amount of residual monomers and the temperature was held constant for two hours. After the second two-hour reaction, the reactor was cooled down to near room temperature before taking the solution sample out of reactor for analysis and performance tests.

Polymer 1 Synthesis: To a 250 mL three-neck round bottom flask was added ethylbromophenylacetate (0.101 g, 0.415 mmol, 1 equiv.), copper(I) bromide (0.057 g, 0.397 mmol, 1 equiv.), pentamethyldiethyltetraamine (0.144 g, 0.831 mmol, 1 equiv.), mPEGMA₉₅₀ methoxy(polyethyleneglycol)_{21.59} methacrylate (95.0 g, 100 mmol, 241 equiv.) and anisole (1:1 v/v to the remaining contents of the flask). The flask was equipped with an overhead stirrer, nitrogen inlet and nitrogen outlet and the solution was deoxygenated by purging with N₂ gas for 30 min. The kettle was heated to a 85° C. and the contents were allowed to react for 7 hours appropriate to achieve a desired molecular weight at 33% conversion. The reaction was quenched by opening to air and rapidly cooling to room temperature. The crude polymer was diluted in THF, eluted through basic alumina to remove the catalyst, collected and concentrated. The product polymer was obtained by precipitation into cold heptanes to afford a pOEGMA950 with an weight average molecular weight (Mw) as determined by gel permeation chromatography (GPC) against a polyacrylic acid standard of 68.5 kDa; the Mw as determined by NMR was 75.6 kDa. The average number of ethoxy groups in the side chains of the brush polymer was 21.59.

Polymer 2 Synthesis: To a 1000 mL 4-neck round bottom flask coupled with a thermo-couple, an overhead stir and a condenser, was added 512.5 grams of de-ionized (DI) water and 29.5 grams of methoxypoly(ethylene glycol),11.3 grams of methacrylate (mPEGMA500) monomer through the 4th neck of the reaction flask. With overhead mixing and under nitrogen flow, the reactants were heated to 70±1° C. using a heating mantle. Once the targeted temperature was achieved, 0.6 grams of a 0.5 wt. % ammonium persulfate (APS) aqueous solution was added to the reactor. A several degree temperature increase, an indicative exotherm signaling the initiation of the polymerization reaction, was observed. The reaction conditions were held for two hours before a second initiator package, 2 grams of a 0.5 wt. % ammonium persulfate (APS) aqueous solution, was added in an effort of reducing the amount of unreacted monomer down to a manageable level. After two more hours, the contents were cooled down to near room temperature before removing a sample for analysis and performance tests.

Polymer 3 Synthesis: The procedure for Polymer 2 was followed using 185 grams of DI water, 1.5 grams of HEMA monomer, 8.6 grams of mPEGMA500 monomer, 2 grams of a 0.50 wt. % APS aqueous solution as the first initiator and 2 grams of a 0.50 wt. % APS aqueous solution as the second initiator.

Polymer 4 Synthesis: The procedure for Polymer 2 was followed using 185 grams of DI water, 2.8 grams of HEMA monomer, 7.2 grams of mPEGMA500 monomer, 2 grams of a 0.50 wt. % APS aqueous solution as the first initiator and 2 grams of a 0.50 wt. % APS aqueous solution as the second initiator.

Polymer 5 Synthesis: The procedure for Polymer 2 was followed using 189.5 grams of DI water, 1.8 grams of MMA monomer, 8.8 grams of mPEGMA475 monomer, 0.4 grams of a 0.50 wt. % APS aqueous solution as the first initiator and 2.0 grams of a 0.50 wt. % APS aqueous solution as the second initiator.

Polymer 6 Synthesis: The procedure for Polymer 2 was followed using 469.3 grams of DI water, 24.9 grams of mPEGMA500 monomer, 0.6 grams of EGDMA x-linker, 0.8 grams of a 0.50 wt. % APS aqueous solution as the first initiator and 2 grams of a 0.50 wt. % APS aqueous solution as the second initiator.

TABLE 1
Acrylic Nonionic Brush Polymers

| Example | Composition¹ | Mw | Solid (wt. %) |
|---|---|---|---|
| Polymer 1 | 100% MPEGMA950 | 68.5 kg/mol | 100 |
| Polymer 2 | 100% MPEGMA500 | 2240 kg/mol | 2.5 |
| Polymer 3 | 85% MPEGMA500/ | 1630 kg/mol | 5.3 |
| | 15% HEMA | | |
| Polymer 4 | 72% MPEGMA500/ | 350 kg/mol | 4.8 |
| | 28% HEMA | | |
| Polymer 5 | 84% MPEGMA475/ | 1340 kg/mol | 4.4 |
| | 16% MMA | | |
| Polymer 6 | 97.6% MPEGMA500/ | n/a² (x-linked) | 5.4 |
| | 2.4% EGDMA | | |

¹All monomer compositions are weight %, based on the total weight of monomers used to make the polymer;
²Crosslinked copolymers have very high molecular weights, estimated above 10,000 kg/mol and could not be determined by GPC.

From Table 1, above, Polymers 3, 4 and 5 are linear acrylic brush polymers. Polymer 6 is a copolymer of MPEGMA500 with a difunctional acrylate giving a cross-linked polymer, which has a molecular weight too high to be determined by GPC; however, such a polymer may be regarded as having an Mw of from 5,000,000 to 20,000,000.

The acrylic brush polymers were tested in a cement mortar formulation, looking at the slump test as an indication of flowability and bleeding (done by visual rating) as an indication of cement segregation or instability. In testing, described below, with the exception of Polymer 1, which was used dry, all polymers were tested as diluted aqueous solutions.

Slump Test: A measure of how much a mortar is able to flow under its own weight and 15 strokes according to DIN EN 1015-3:2007-05 (Beuth Verlag GmbH, Berlin, DE). In the test, the user places a cone funnel (slump cone) having a bottom opening diameter of 100 mm, a top opening diameter of 70 mm and a height of 60 mm onto a wetted glass plate with the bottom opening on the plate (wetted 10 seconds before testing). Then, one fills the cone with mortar and then quickly pulls the cone vertically off from the plate to fully release the mortar onto the plate followed by applying 15 strokes to the mortar. Once the mortar ceases to spread, the user measures the diameter of the resulting mortar cake in four locations spaced equally around the mortar cake. The average of the four diameters is the slump value for the mortar.

The mortar was prepared using the components of Table 2, below, by first preparing a drymix by combining all dry components, followed by combining the wet components like water and polycarboxylate ester superplastizer in a mixing bowl for a ToniMIX mixer (Toni Technik Baustoffprüfsysteme GmbH, Berlin, DE). While mixing on mixing level one (lower speed), the drymix was added to the mixing bowl and the resulting paste was mixed for 30 seconds on level one and then for 30 seconds on level two (higher speed). The mixture was allowed to rest for 90 seconds to dissolve the additives, and then was mixed again for 60 seconds on level two. In each formulation, a cement admixture resulted with a water/cement ratio set to 0.51.

TABLE 2
Mortar Formulation

| Material | Amount (g) |
|---|---|
| OPC CEM I 42,5 R (HDZ/Ennigerloh Nord, DE) | 500 |
| Ordinary portland cement | |
| Sand H32 (Quarzwerke Frechen, DE) | 500 |
| Sand 0.2/1 (Quarzwerke Frechen, DE) (particle size 0.2 to | 600 |
| 1 mm, mesh sieved) | |
| Sand 1/2 (Quarzwerke Frechen, DE) (particle size 1 to 2 m, | 400 |
| mesh sieved) | |
| Glenium ™^{,1} 51(1.0 wt. % on cement solids) | 5.0 |
| (BASF, Ludwigshafen, DE) | |
| Blend of brush polymer and cofactor² as in Table 3, below | See Table 3 |
| (0.05 wt. % on cement solids) | |
| Water (at a water/cement ratio 0.51) | 255 |

¹Polycarboxylate ester superplasticizer having a polymethacrylic acid backbone with grafted MPEG 1000 side chains (38 mol % of the methacrylate acid units are esterified).
²Melcrete™ 500 L poly (naphthalene sulfonate) formaldehyde condensate in liquid form (solids 40 wt. %).

As shown in Table 3, below, various formulations of the additive in cement admixtures were tested. Without any additive, as in comparative Example 1, the mortar has a good flow of 243 mm, but shows strong bleeding indicating that the mortar strongly segregates. As shown in comparative Example 2, cellulose ethers like hydroxyethyl methylcellulose can be successfully used as a viscosity modifying agent (VMA), they slightly reduce the flow of the mortar; however, they also stabilize the aggregates in the cement admixture resulting in no bleeding. As shown in comparative Examples 3, 4, and 5, addition of acrylic brush Polymer 1 at 0.05% and 0.10% and acrylic brush Polymer 2 at 0.05% has no effect on the flow properties and does not stabilize the mortar. Acrylic brush Polymer 1 has a plasticizing effect further improving the flow by a few millimeters. In contrast with these examples, when an acrylic brush Polymer (Polymer 2) was combined with an aromatic cofactor, beta-naphthalene sulfonate condensates poly(BNS) and a polycarboxylate ester polymer, the flow properties of the polymer are slightly reduced, evidencing thickening, and the cement does not bleed anymore. It is not known that one can get such an effect without cellulose ethers or polysaccharide VMAs.

In Table 4, below, more additives were tested in cement admixtures and in these admixtures, unless otherwise indicated, the additive (excluding the polycarboxylate ester from Table 1, above) was used in the amount of 0.05 wt. %, based on total solids of the cement, and the weight ratio of the indicated acrylic brush Polymer and any indicated aromatic cofactor is 1:1. In addition, in the Examples in Table 4, below, the water to cement ratio (w/c-ratio) was adjusted to 0.53:1, a high water content for evaluating a wide formulation window. The reference HEMC begins slightly to bleed. This examples evaluate the additive of the present invention under more challenging conditions where bleeding occurs more easily.

TABLE 3
Cement Admixture Performance

| | Additive Blend² | Slump | |
|---|---|---|---|
| Example | (on cement solids) | (mm) | Bleeding |
| 1* | No additive (VMA) | 243 | yes |
| 2* | 0.05% hydroxyethyl | 225 | no |
| | methylcellulose¹ | | |
| 3* | 0.05% Polymer 1 | 249 | yes |
| 4* | 0.10% Polymer 1 | 245 | yes |
| 5* | 0.05% Polymer 2 | 243 | yes |
| 6 | 0.05% Polymer 2 | 229 | no |
| | 0.05% Polymer 2 and | | |
| | 0.05% Melcrete ™^{,3} | | |
| | 500 L | | |

* denotes Comparative Example;
¹Walocel MKX 6000 PF 01 cellulose ether (Dow Chemical, Midland, MI);
²Polycarboxylate ether is from Table 2;
³BASF, Ludwigshafen, DE.

TABLE 4
Cement Admixture Performance

| | | Slump | | Appearance of |
|---|---|---|---|---|
| Example | Additive Blend² | (mm) | Bleeding | additive solution |
| 7* | No VMA | 250 | yes | fully homogeneous mix |
| 8* | Hydroxyethyl | 249 | slightly | precipitation of HEMC |
| | methylcellulose¹ | | | |
| 9* | Polymer 3 | 246 | yes | fully homogeneous mix |
| 10* | Polymer 4 | 252 | yes | fully homogeneous mix |
| 11* | Polymer 5 | 239 | yes | fully homogeneous mix |
| 12* | Polymer 6 | 251 | yes | fully homogeneous mix |
| 13 | Polymer 3/BNS | 257 | no | fully homogeneous mix |
| 14 | Polymer 4/BNS | 254 | slightly | fully homogeneous mix |
| 15 | Polymer 5/BNS | 246 | no | fully homogeneous mix |
| 16 | Polymer 6/BNS | 251 | no | fully homogeneous mix |
| 17* | only BNS | 248 | yes | fully homogeneous mix |
| 18* | Polyethylene | 255 | no | extreme thickening |
| | Oxide (PEO)³ | | | |
| 19* | PEO³/BNS | 253 | yes | extreme thickening |

*denotes Comparative Example;
¹Walocel MKX 6000 PF 01 cellulose ether (The Dow
Chemical Company, Midland, MI);
²Polycarboxylate ester is in all Examples;
³Polyox ™ WSR 301 high molecular weight (Mw 6 Million Dalton) polyethyleneoxide (Dow Chemical).

As shown in Table 4, above, various formulations of the additive in cement admixtures were tested. As shown in Example 13-16 in comparison to comparative Examples 9-12, the acrylic brush Polymers perform well in insuring slump and preventing bleeding after the addition of the aromatic cofactor BNS. In Example 14, the acrylic brush Polymer 4 performs as well as HEMC in Example 8, whereas the Examples 13, 15 and 16 additives of the present invention are better than the cellulose ether in terms of preventing bleeding. At the higher water/cement ratio in these formulations, the slump performance of the admixtures does not seem to be impacted by the choice of the VMA, varying within a range of 239 mm and 257 mm. All of the inventive Examples 13 to 16 provide a stable additive as a wet additive, containing the acrylic brush Polymer, the polycarboxylate ester, and the aromatic cofactor. The polyethylene oxide in comparative examples 18-19 fails to provide a stable additive separate from the cement, and is not shelf stable. Such polyethylene oxide thickens the mortar and prevents bleeding. However, as shown in comparative Example 19, an aromatic cofactor does not work with the polyethylene oxide to prevent bleeding; rather, it appears to bind to the cement particle surface and works as a dispersant making the admixture segregate slightly, resulting in bleeding.

As shown in the right hand column of Table 4, above, in addition to the performance tests in cement admixtures, all inventive acrylic brush Polymers of this invention are fully compatible with aqueous polycarboxylate ether copolymer (PCE) water reducer solutions. In contrast, the cellulose ether of comparative Example 8 does not go in solution and precipitates at the bottom of the glass container. Likewise, the polyethylene oxide when blended in a PCE solution, the result is an extremely thick admixture wherein pouring is not possible. Such a blend would not be acceptable in the industry.

Storage Stability: A composition of 5:5:100, by weight as solids, of the brush polymer of Example 6 (Table 3, above), the aromatic cofactor of Example 6 BNS, Table 3, above) and the Glenium™ 51 (BASF, Ludwigshafen, DE) polycarboxylate ether was combined to make an aqueous composition having about 35-37 wt. % solids. The composition was left to sit in a covered glass jar at room temperature and standard pressure. After just over 4 days, the solution flowed well, and had no visible gel or precipitate although it was more viscous on the bottom of the jar.

We claim:

1. A composition for use as a stable additive concentrate in cement admixture compositions comprising i) one or more nonionic or substantially nonionic vinyl or acrylic brush polymers having pendant or side chain polyether groups and having a relative weight average molecular weight (relative Mw) of from 140,000 to 50,000,000 g/mol, ii) one or more aromatic cofactors containing one or more phenolic groups or, in combination, one or more aromatic groups with at least one sulfur acid group; and iii) one or more polycarboxylate ether copolymer water reducers containing carboxylic acid or salt groups and having polyether side chains and a weight average molecular weight of from 5,000 to 100,000.

2. The composition as claimed in claim 1, wherein the ii) one or more aromatic cofactor is chosen from a naphthalene sulfonate aldehyde condensate polymer, a poly(styrene-co-styrene sulfonate) copolymer, lignin sulfonates, catechol tannins, phenolic resins, polyphenolics, napthhol, and mixtures thereof.

3. The composition as claimed in claim 1, wherein the i) one or more vinyl or acrylic brush polymers has a relative weight average molecular weight of from 250,000 to 5,000,000.

4. The composition as claimed in claim 1, wherein the average number of ether groups in the pendant or side chain polyether groups of the i) one or more vinyl or acrylic brush polymers ranges from 1.5 to 100 ether groups.

5. The composition as claimed in claim 1, wherein the i) one or more brush polymers is chosen from a polyethoxylated polyvinyl alcohol; a homopolymer of a macromonomer a) having a pendant or side chain polyether group; a copolymer of one or more macromonomers a) and one or more monomers b) chosen from lower alkyl (C₁ to C₄) alkyl (meth)acrylates, hydroxyalkyl (meth)acrylates, diethylenically unsaturated crosslinker monomers and mixtures thereof.

6. The composition as claimed in claim 1, wherein the i) one or more vinyl or acrylic brush polymers has a backbone a polymer of (meth)acrylic acid and a side chain of one or more polyether polyol, alkyl polyether polyol, polyether amine or alkyl polyether amine side chains bound to the backbone through a carboxylic acid ester linkage.

7. The composition as claimed in claim 1, wherein at least one iii) polycarboxylate ether copolymer water reducer has a weight average molecular weight of from 10,000 to 100,000.

8. The composition as claimed in claim 1 which comprises a stable aqueous additive mixture having a solids content of from 25 to 70 wt. %.

9. The composition as claimed in claim 1, further comprising a hydraulic or moisture curing inorganic cement, wherein the total amount of the i) one or more vinyl or acrylic brush polymers, as solids, ranges from 0.05 to 2 wt. %, based on total cement solids.

10. A method for making the compositions as claimed in any one of claims 1 to 8, comprising adding the i) one or more vinyl or acrylic brush polymers and the ii) one or more aromatic cofactors in any form to an aqueous solution of the iii) one or more polycarboxylate ether copolymer water reducers to form an aqueous additive mixture for use in wet hydraulic cement.

11. A method for using the compositions of any of items 1 to 7, above, comprise adding the i) one or more vinyl or acrylic brush polymers in any form to the wet hydraulic cement and then adding, one at a time or together, preferably, as an aqueous mixture, ii) one or more aromatic cofactors and the iii) one or more polycarboxylate ether copolymer water reducers, to form a cement admixture.
